(19) United States
(12) Patent Application Publication
(10) Pub. No.: US 2026/0268132 A1
(43) Pub. Date: Sep. 10, 2026

(54) COHERENT PHOTONIC NEURAL NETWORK INTEGRATED CIRCUITS FOR COMPLEX VALUE AND FOURIER DOMAIN MATRIX PROCESSING ACCELERATORS

(71) Applicant: TAARA CONNECT, INC., Sunnyvale, CA (US)

(72) Inventors: Stephen Palese, Menlo Park, CA (US); Paul Epp, Sunnyvale, CA (US)

(21) Appl. No.: 19/535,473

(22) Filed: Feb. 10, 2026

Related U.S. Application Data
(60) Provisional application No. 63/767,637, filed on Mar. 6, 2025.

(51) Int. Cl. G06N 3/067

(52) U.S. Cl. CPC G06N 3/067

(57) ABSTRACT

Aspects of the disclosure relate to an optical neural network (ONN) implemented using photonic integrated circuits (PIC). The ONN may be used in image analysis. The ONN may include a plurality of layers disposed on a single PIC. The plurality of layers may include an input layer, a first lens, one or more convolution layers, a second lens, and an analyzer layer. In this regard, the plurality of layers of the ONN may be used in image analysis. The plurality of layers may analyze the images via processing when the images are encoded on signals. The signals may be light-based signals including.

### A CROSS REFERENCE TO RELATED APPLICATIONS

The present application claims the benefit of the filing date of U.S. Provisional Application No. 63/767,637, filed Mar. 6, 2025, the entire disclosure of which is incorporated by reference herein.

### BACKGROUND

Image processing, recognition, classification is one of the most computer resource intensive processes that exists with over 750 billion images on the internet and greater than three billion more every day. In order for efficient search, these are processed using neural networks to identify key features such as color, textures, edges, patterns, etc. These features may be fed into systems including deep learning neural networks trained to understand images and subsequently stored in the database and indexed. In this regard, when customers search with the input image, these systems provide the most visually similar images. Processing may require a large computational resource overhead given the large number of images. With the rapidly increasing complexity in data manipulation techniques and dataset size, highly integrated and scalable photonics hardware with ultracompact size and the reduced energy consumption may be needed to avoid the resource bottleneck in artificial neural networks.

### BRIEF SUMMARY

Aspects of the disclosure provide a system. The system comprising an optical neural network (ONN) photonic integrated circuit (PIC) formed as a plurality of layers, the ONN PIC comprising an input layer, the input layer configured to transmit signals including one or more test patterns, wherein each test pattern represents an image to be analyzed, one or more convolution layers, the one or more convolution layers configured to filter received signals including one or more test patterns based on one or more target patterns, and an analyzer layer, the analyzer layer configured to compare filtered signals from the one or more convolution layers to one or more thresholds; and an optical control subsystem operatively connected to the ONN PIC, the optical control subsystem configured to generate one or more control wavelengths including one or more frequency tones, wherein the one or more control wavelengths are configured to assist with determinations of where phase errors occur within the ONN PIC.

In one example, the ONN PIC is included on a photonic portion of a board, the board comprising the photonic portion and an electronic portion including one or more electronic components. Additionally, the optical control subsystem may be included on the photonic portion of the board. Alternatively, the optical control subsystem may be external to the board.

In an additional example, the input layer, the one or more convolution layers, and the analyzer layer are connected via one or more waveguides.

In another example, the ONN PIC is a plurality of ONN PICS. Additionally, the plurality of ONN PICS may each be included on a photonic portion of a corresponding board of a plurality of boards, each corresponding board comprising a photonic portion and an electronic portion including one or more electronic components. Additionally, the optical control subsystem may be external to the plurality of boards. Additionally or alternatively, each target pattern of the one or more target patterns may include a plurality of components; and each ONN PIC of the plurality of ONN PICs may receive a different component of the plurality of components for each target pattern. Additionally, each ONN PIC of the plurality of ONN PICs may receive the different component of the plurality of components for each target pattern simultaneously.

In a further example, the system also includes a first lens disposed in a path between the input layer and the one or more convolution layers, the first lens configured to perform a Fourier Transform (FT) on signals passing therethrough. Additionally, the system may also include a second lens disposed in a path between the one or more convolution layers and an analyzer layer, the second lens configured to perform inverse Fourier Transform (IFT) on signals passing therethrough. Additionally, the FT may be Fast Fourier Transform (FFT) and the IFT may be an inverse Fast Fourier Transform (IFFT). Additionally or alternatively, the first lens may be a meta-lens. Alternatively, the first lens may be a stacked interlayered multiple planar diffractive cell layer.

In another example, the comparison results in a determination of a class of a test pattern or recognition of an image in the test pattern.

In an additional example, the ONN PIC further comprises a first reflector disposed at an output of the input layer; a second reflector disposed at an output of the one or more convolution layers; and a third reflector disposed at an output of the analyzer layer, wherein the first reflector, second reflector, and third reflector are configured to reflect the one or more control wavelengths to one or more detectors. Additionally, the one or more detectors may be in a separate plane from the ONN PIC.

In a further example, the one or more thresholds is a confidence level threshold. In another example, the one or more thresholds is a plurality of thresholds and each of the plurality of thresholds corresponds to a different component of a test pattern of the one or more test patterns.

### BRIEF DESCRIPTION OF DRAWINGS

FIG. 1 is a block diagram in accordance with aspects of the disclosure.

FIG. 2 is a pictorial diagram in accordance with aspects of the disclosure.

FIG. 3A is a block diagram in accordance with aspects of the disclosure.

FIG. 3B is a pictorial diagram in accordance with aspects of the disclosure.

FIG. 4A is a block diagram in accordance with aspects of the disclosure.

FIG. 4B is a block diagram in accordance with aspects of the disclosure.

FIG. 6 is a block diagram in accordance with aspects of the disclosure.

FIG. 7 is a block diagram in accordance with aspects of the disclosure

FIG. 8A is a pictorial diagram in accordance with aspects of the disclosure.

FIG. 8B is a pictorial diagram in accordance with aspects of the disclosure.

### DETAILED DESCRIPTION

### Overview

The technology relates to an optical neural network (ONN) implemented using photonic integrated circuits (PIC). The ONN implemented using PICs may be used in image analysis. The ONN may include a plurality of layers disposed on a single PIC or discrete PICs. The plurality of layers may include an input layer, a first lens, one or more convolution layers, a second lens, and an analyzer layer. In this regard, the plurality of layers of the ONN may be used in image analysis. The plurality of layers may analyze the images via processing when the images are encoded on signals. The signals may be light-based signals including, in some instances, optical beams including communications signals. The analysis of images may serve different purposes. As such, in one instance, the ONN may classify images. In another instance, the ONN may recognize images. Additionally, one or more of the plurality of layers may include an optical phased array (OPA). The OPA(s) may be one or two dimensional (2D).

The features and methodology described herein may provide a scalable ONN capable of processing large amounts of data and perform complex operations without the hindrances of electronic counterparts. In this regard, the ONN may utilize the scalability of the OPA to compute complex matrix-vector multiplication, have the advantages of ultra-high bandwidth, high calculation speed, high parallelism over electronic counterparts, and ultralow power consumption. Moreover, the PIC approach configured with OPAs leverages advances in complementary metal oxide semiconductor (CMOS) fabrication technologies to replace bulk centimeter sized ONN components with integrated micron level semiconductor photonics constructs. These CMOS compatible photonics can be directly integrated with CMOS electronics to provide complete ONN chips akin to electronic central processing unit (CPU) and graphics processing unit (GPU). This also allows ONN chip manufacture at the volume and cost scale required for next generation wide-spread speech recognition, image classification, computer vision and natural language processing applications. Additionally, extra dimensions enable system improvements such as wavelength division and spatial mode multiplexing that provides multi-thread processing with almost no extra computing overhead, leading to ultralow energy consumption that can drive system key performance metrics.

### EXAMPLE SYSTEMS

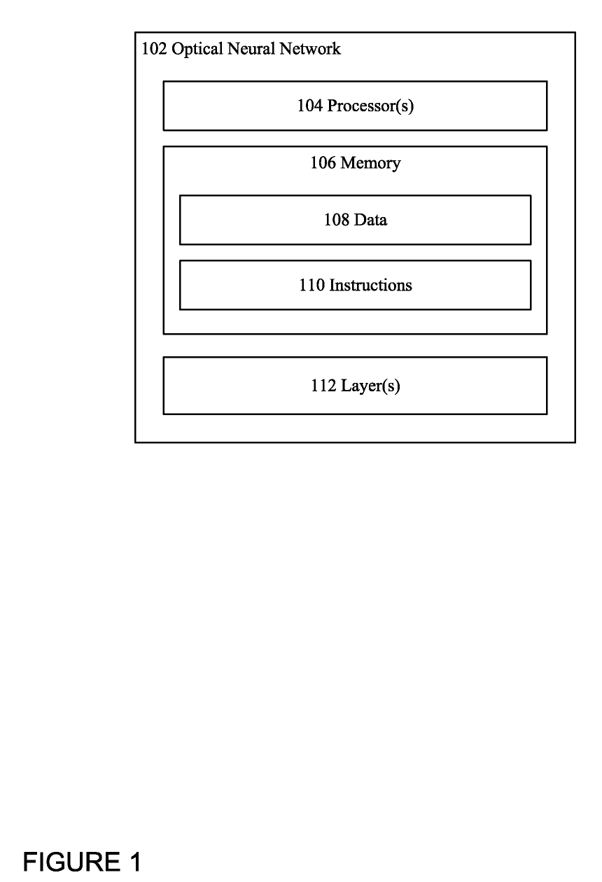

As noted above, an ONN implemented using PICs may include a plurality of layers. FIG. 1 illustrates an example ONN 102. The example ONN 102 includes one or more processors 104, a memory 106, and a plurality of layers 112. The one or more processors 104 may be any conventional processors, such as commercially available CPUs. For example, one or more processors 104 may be one or more complementary metal-oxide semiconductor (CMOS) processors. Alternatively, the one or more processors 104 may be a dedicated device such as an application specific integrated circuit (ASIC) or another hardware-based processor, such as a field programmable gate array (FPGA). Although FIG. 1 functionally illustrates the one or more processors 104 and memory 106 as being within the same block, the one or more processors 104 and memory 106 may actually comprise multiple processors and memories that may or may not be stored within the same physical housing. Accordingly, references to a processor or computer will be understood to include references to a collection of processors or computers or memories that may or may not operate in parallel.

Memory 106 may store information accessible by the one or more processors 104, including data 108, and instructions 110, that may be executed by the one or more processors 104. The memory 106 may be of any type capable of storing information accessible by the processor, including a computer-readable medium such as a hard-drive, memory card, ROM, RAM, DVD or other optical disks, as well as other write-capable and read-only memories. The system and method may include different combinations of the foregoing, whereby different portions of the data 108 and instructions 110 are stored on different types of media.

Data 108 may be retrieved, stored or modified by one or more processors 104 in accordance with the instructions 110. For instance, although the system and method are not limited by any particular data structure, the data 108 may be stored in computer registers, in a relational database as a table having a plurality of different fields and records, XML documents or flat files. The data 108 may also be formatted in any computer-readable format such as, but not limited to, binary values or Unicode. By further way of example only, image data may be stored as bitmaps including grids of pixels that are stored in accordance with formats that are compressed or uncompressed, lossless (e.g., BMP) or lossy (e.g., JPEG), and bitmap or vector- based (e.g., SVG), as well as computer instructions for drawing graphics. The data 108 may comprise any information sufficient to identify the relevant information, such as numbers, descriptive text, proprietary codes, references to data stored in other areas of the same memory or different memories (including other network locations) or information that is used by a function to calculate the relevant data.

The instructions 110 may be any set of instructions to be executed directly (such as machine code) or indirectly (such as scripts) by the one or more processors 104. For example, the instructions 110 may be stored as computer code on the computer-readable medium. In that regard, the terms "instructions" and "programs" may be used interchangeably herein. The instructions 110 may be stored in object code format for direct processing by the one or more processors 104, or in any other computer language including scripts or collections of independent source code modules that are interpreted on demand or compiled in advance. Functions, methods and routines of the instructions 110 are explained in more detail below.

The plurality of layers 112 may include an input PIC, a first lens or photonic construct, one or more convolution PIC layers, a second lens or photonic construct, and an analyzer PIC. In some instances, a target PIC may be included at the one or more convolution PIC layers. In some instances, the plurality of layers may be 2D layers. In this regard, the plurality of layers may be scalable in 2D, enabling a path to larger formats that can handle larger image files without the need to be decomposed into sub-images for processing

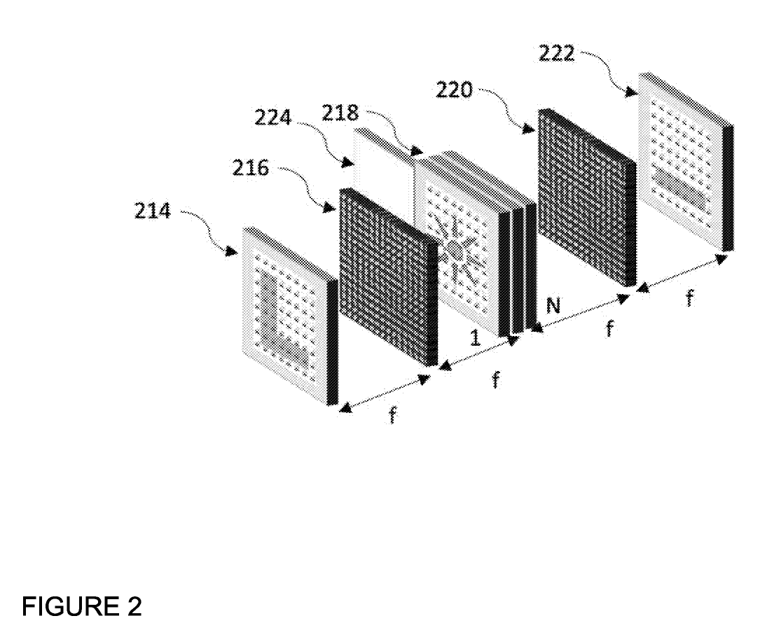

FIG. 2 illustrates an example ONN configuration including a plurality of layers, corresponding to the plurality of layers 112. One or more of the layers may be 2D layers. As shown in FIG. 2, the plurality of layers includes an input PIC 214, first lens or photonic construct 216, one or more convolution PIC layers 218, second lens or photonic construct 220, an analyzer PIC 222, and a target PIC 224. One or more of the plurality of layers may be separated by a distance f. For example and as illustrated, the input PIC 214 and first lens 216 are separated by a distance f; the first lens 216 and one or more convolution PIC layers 218 are separated by a distance f; the one or more convolution PIC layers 218 and the second lens 220 are separated by a distance f; and the second lens 220 and the analyzer PIC 222 are separated by a distance f. In such an example, a 4f ONN system architecture is depicted. The distance f may be a focal length associated with the components of the ONN, an effective Fourier transform length associated with the first and second lens of the ONN or a combination thereof.

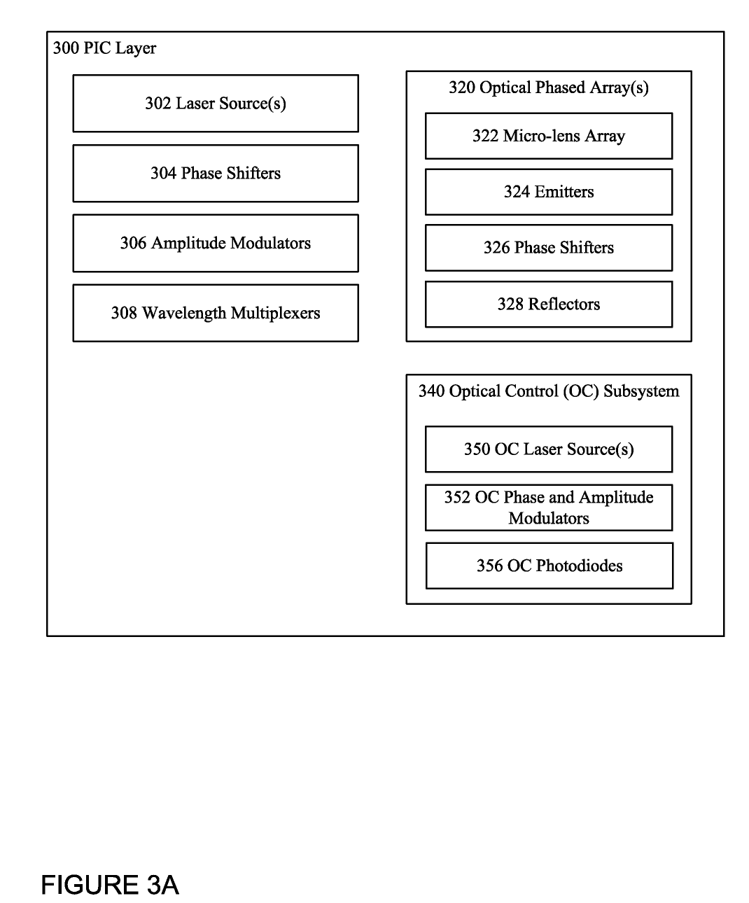

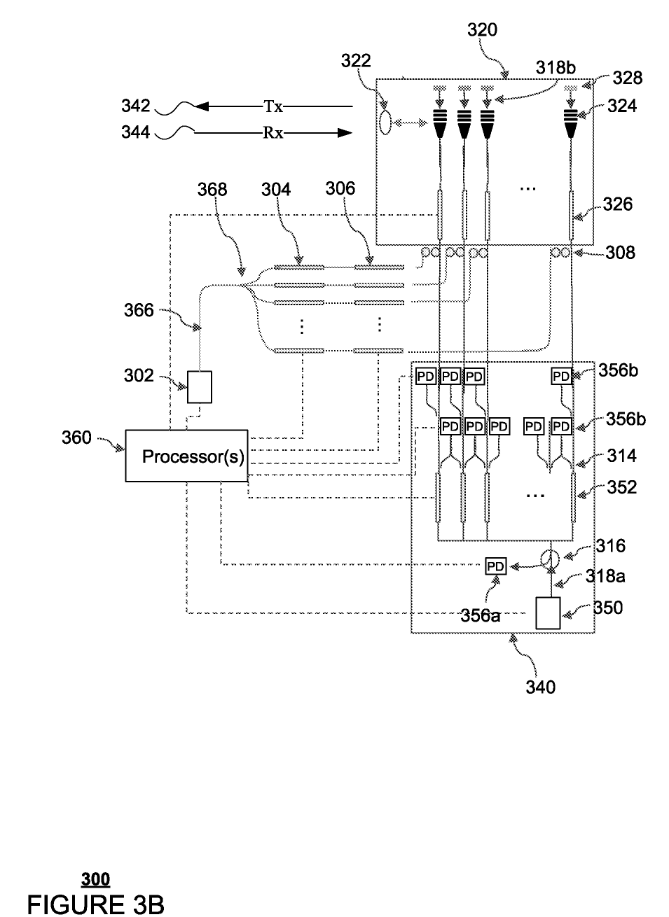

FIG. 3A illustrates an example block diagram of a PIC layer 300, which may correspond to input PIC 214, one or more convolution PIC layers 218, and target PIC 224. The PIC layer 300 includes one or more laser sources 302, a plurality of phase shifters 304, a plurality of amplitude modulators 306, a plurality of wavelength multiplexers 308, one or more OPAs 320, and an optical control (OC) subsystem 340. In some instances, the PIC layer 300 may additionally include a plurality of photodiodes for PDs. The plurality of PDs may be configured to measure one or more values such intensity and/or power.

The one or more OPAs 320 includes a micro-lens array 322, a plurality of emitters 324, a plurality of phase shifters 326, and a plurality of reflectors, partial reflectors, or retroreflector photonic constructs 328. The OC subsystem 340 includes one or more OC laser sources 350, a plurality of OC phase and amplitude modulators 352, and plurality of OC PDs 356. The components of the OC 340 may be used for phase and wavefront control. In this regard, the OC subsystem 340 may be configured to correct static and dynamic relative or absolute phase errors throughout the PIC layer 300 via the generation of one or more control wavelengths. The PIC layer 300 may also include other photonic and CMOS electronic components that may support signal processing therein. The signals can be light-based signals including, in some instances, optical beams including communications signals. The components of the PIC layer 300 may be connected via a plurality of waveguides or optical fibers. The one or more laser sources 302 and/or the one or more OC laser sources 350 may have a narrow linewidth specification (e.g., less than 500 kHz) and can serve as local oscillators for a coherent detector array architecture in the PIC layer 300.

FIG. 3B illustrates a corresponding example pictorial representation of PIC layer 300 including laser source 302, a plurality of phase shifters 304, a plurality of amplitude modulators 306, a plurality of wavelength multiplexers or demultiplexers 308, an OPA 320, an optical control (OC) subsystem 340, one or more processors 360, waveguide 366, and 1 x N splitter 368. For clarity and ease of understanding, additional waveguides and other features are not fully depicted. Arrows 342 and 344 represent the general direction of transmitted and received signals respectively as such signals leave and enter the PIC layer 300. In some instances, the PIC layer 300 may additionally include a plurality of photodiodes or “PDs”. The plurality of PDs may be configured to measure one or more values such intensity and/or power.

FIG. 3B also includes representations of a micro-lens array 322, a plurality of emitters 324, a plurality of phase shifters 326, and reflectors, partial reflectors, or retroreflector photonic constructs 328 of the OPA 320. For clarity and ease of understanding, additional waveguides and other features are not depicted. Arrows 342 and 344 represent the general direction of transmitted (Tx) and received (Rx) signals, respectively, as such signals leave and enter the PIC layer 300.

The micro-lens array 322 may include a plurality of convex micro-lenses that focus the light of an Rx signal onto respective ones of the plurality emitters positioned at the focal points of the micro-lens array 322. The micro-lens array 322 may be arranged in a grid pattern with a consistent pitch, or distance, between adjacent lenses. In other examples, the micro-lens array 322 may be in different arrangements having different numbers of rows and columns, different shapes, and/or different pitch (consistent or inconsistent) for different lenses.

Each micro-lens of the micro-lens array may be 1’s, 10’s, or 1000's of micrometers in diameter and/or height. In addition, each micro-lens of the micro-lens array 322 may be manufactured by molding, printing, or etching a lens directly into a wafer of the OPA 320 of PIC layer 300. Alternatively, the micro-lens array 322 may be molded, printed, or etched as a separately fabricated micro-lens array. In this example, the micro-lens array 322 may be a rectangular or square plate of glass or silica a few mm (e.g., 20 mm or more or less) in length and width and 0.76 mm or more or less thick. Integrating the micro-lens array within the OPA 320 may allow for the reduction of grating emitter size and an increase in the space between emitters. In this way, two-dimensional waveguide routing in the OPA may better fit in a single layer optical phased array. In other instances, rather than a physical micro-lens array, the function of the micro-lens array may be replicated using an array of diffractive optical elements (DOE).

Each micro-lens of the micro-lens array 322 may be associated with a respective emitter of the plurality of emitters 324. For example, each micro-lens may have an emitter from which Tx signals are received and to which Rx signals are focused. In this regard, for a given pitch (i.e., edge length of a micro-lens) the micro-lens focal length may be optimized for best transmit and receive coupling to the underlying emitters. This arrangement may thus increase the effective fill factor of the light of the Rx signal at the respective emitter, while also expanding the light of the Tx signal received at the micro-lenses from the respective emitter before the Tx signal leaves the OPA 320.

The plurality of emitters 324 may be configured to convert emissions from waveguides to free space and vice versa. The emitters may also generate a specific phase and intensity profile to further increase the effective fill factor of the light of an Rx signal and improve the wavefront of the light of a Tx signal. The phase and intensity profile may be determined using inverse design or other techniques in a manner that accounts for how transmitted light will change as it propagates to and through the micro-lens array. The phase profile may be different from the flat profile of traditional grating emitters, and the intensity profile may be different from the gaussian intensity profile of traditional grating emitters. However, in some implementations, the emitters may be Gaussian field profile grating emitters.

The plurality of phase shifters 326 may allow for sensing and measuring Rx signals, controlling of the relative phase of Tx signals, and the altering of Tx signals to improve complex-value calculation fidelity from the between PIC layers. Each emitter may be associated with a respective phase shifter. The Rx signals received at the plurality of phase shifters 326 may be provided to receiver components including a sensor, the Tx signals from the plurality of phase shifters 326 may be provided to the respective emitters of the plurality of emitters 324. The architecture for the plurality of phase shifters 326 may include at least one layer of phase shifters having at least one phase shifter connected to an emitter of the plurality of emitters 324. In some examples, the phase shifter architecture may include a plurality of layers of phase shifters, where phase shifters in a first layer may be connected in series with one or more phase shifters in a second layer. In some instances, the plurality of emitters 324 may be a plurality of optical antennas.

The plurality of reflectors 328 may be configured to reflect signals transmitted from the plurality of emitters 324, such as one or more control wavelengths represented by arrow 318b, back to the plurality emitters 324. As shown in FIG. 3B, the one or more reflectors 328 may be a plurality of reflectors, and may each correspond to an emitter of the plurality of emitters 324.

The one or more processors 360 may be configured to drive the OC subsystem 340 to generate one or more control wavelengths. The one or more control wavelengths may assist with phase and wavefront control. The OC subsystem 340 of FIG. 3B includes a laser source 350, a plurality of OC phase and amplitude modulators 352, a plurality of OC PDs 356, one or more waveguide tap couplers 314, and a photonic circulator 316. The OC subsystem 340 and one or more control wavelengths thereof may be used as a reference to correct static and dynamic phase errors throughout the PIC layer 300 to control the relative or absolute phase of individual emitter pathways, and may allow for slightly different functionality across one or more of the plurality of layers 112 of the ONN 102. The one or more processors 360 may be configured to induce the OC laser source 350 to generate one or more control wavelengths. The one or more control wavelengths may be propagated along the waveguides of the PIC layer 300 as illustrated by arrows 318a and 318b.

The plurality of OC phase and amplitude modulators 352 may be included in one or more layers as illustrated in FIG. 3B. The plurality of OC phase and amplitude modulators 352 may be operatively coupled to the plurality of OC PDs 356b. The plurality of OC PDs 356b may be coupled to each phase and amplitude modulator. FIG. 3B further illustrates that individual PDs of the plurality of OC PDs 356b may be coupled to two or more phase and amplitude modulators of the plurality of OC phase and amplitude modulators 352 via a waveguide tap coupler, such as waveguide tap coupler 314. The plurality of OC PDs 356 may be configured to measure one or more values such intensity, power, and/or relative phase of the one or more control wavelengths. The measured values may be used in control and/or analysis of the one or more control wavelengths (e.g., as feedback) by the one or more processors 360. In this regard, the one or more processors 360 may use the measured values in control and/or the analysis of components of the OC subsystem 340 (e.g., the plurality of OC phase and amplitude modulators 352).

In some instances, differing PDs may be configured to measure values at different waveguides of a phase and amplitude modulator layer to determine a relative phase. For example, an arrangement may include one PD measuring the intensity/power of a waveguide A, one PD measuring the intensity/power of an adjacent waveguide B, and one PD measuring the relative phase between waveguide A and B by mixing the two signals on one PD. Such an arrangement may provide the basic building block for the PD measurement system of the plurality of PDs. In addition, the same or a similar arrangement may be repeated for adjacent waveguides (e.g., B and C, C and D, and so forth). The measured values, measured by the 3 example PDs for waveguides A-B, may be represented as A², B², and A² +B² +2ABcos𝝋_{AB} respectively. The three measured values may allow for the determination of 𝝋_{AB,} or the relative phase of the signals propagating via waveguides A and B. Absolute phase measurements are also possible by using a fraction of the control wavelength(s) as a local oscillator to coherently interfere with the retro-reflector control wavelengths which are propagated back and forth through the PIC at the plurality of PDs. This may require an additional plurality of phase and amplitude modulators in the local oscillator paths with associated feedback electronics to phase lock the two together.

As discussed above, the plurality of reflectors 328 of the OPA 320 may be configured to reflect signals transmitted from the plurality of emitters 324, such as one or more control wavelengths represented by arrow 318b, back to the plurality emitters 324. The one or more reflected back control wavelengths may propagate through the PIC layer 300 and be directed to OC PD 356a via circulator 316. The measured value of signal measured by OC PD 356a may be processed by the one or more processors 360. The measured values may be used in control and/or the analysis of components of the PIC layer 300.

The one or more processors 360 as illustrated are operatively connected to the plurality of OC phase and amplitude modulators 352, and the plurality of OC PDs 356. In this regard, the one or more processors 360 may be configured to drive (e.g., modify the phase and/or amplitude) of the plurality of OC phase and amplitude modulators 352. Additionally, the one or more processors 360 may be configured to utilize value(s) measured by the plurality of OC PDs 356 to drive the plurality of OC phase and amplitude modulators 352.

For example, measured values, as discussed above, from the plurality of OC PDs 356 may be used in the control (e.g., to drive) the plurality of OC phase and amplitude modulators 352. In some instances, the one or more processors 360 may use the measured values both to compensate for determined phase errors (e.g., at the plurality of OC phase and amplitude modulators 352) as well as to drive the plurality of phase shifters 326 of the OPA 320 to provide a particular phase to the plurality of emitters 324.

The one or more processors 360 may be any conventional processors, such as commercially available CPUs. For example, one or more processors 360 may be one or more complementary metal-oxide semiconductor (CMOS) processors. Alternatively, the one or more processors 360 may be a dedicated device such as an application specific integrated circuit (ASIC) or another hardware-based processor, such as a field programmable gate array (FPGA). The one or more processors 360 may be operatively connected to the plurality of phase shifters 326 of the OPA 320, the laser source 302, the plurality of phase shifters 304, the plurality of amplitude modulators 306, the laser source 350 of the OC subsystem 340, the OC phase and amplitude modulators 352, and the OC PDs 356.

The one or more processors 360 may be configured to induce the laser signal source 302 to generate signals (e.g., optical beams) to be propagated via the waveguide 366. The 1 x N splitter 368 may be configured to split signals from waveguide 366 such that the signals may be routed into the plurality of phase shifters 304 and the plurality of amplitude modulates 306. The one or more processors 360 may be configured to drive the plurality of phase shifters 304 and the plurality of amplitude modulators 306 to allow for control of one or more characteristics of signals propagated therethrough. In some instances, the one or more processors 360 may be the same or included in one or more processors 104 of the ONN 102. Additionally or alternatively the one or more processors 360 may include at least one processor specific to the PIC layer 300. Additionally or alternatively, the one or more processors 360 of the PIC layer 300 may include at least one processor specific to the OC subsystem 340.

The plurality of multiplexers 308 may be configured to receive signals from the plurality of phase shifters 304 and the plurality of amplitude modulators 306 and one or more control wavelengths from the OC subsystem 340. The plurality of multiplexers 308 are further configured to direct such signals and one or more control wavelengths to the OPA 320. The plurality of multiplexers 308 may be additionally configured to direct signals received at the plurality of emitters 324 to one or more components configured to assist with reception and directed reflected back one or more control wavelengths to the OC subsystem 340. In some instances, one or more multiplexers or demultiplexers 308 may route signals (e.g., reflected back control wavelength(s) 318b and Rx signals 344) to one or more of the plurality of OC PDs 356 for detection, electronic amplification and buffering, and/or analog to digital conversion.

In some instances, to maximize bandwidth, waveguide pathlengths may be matched from the 1 x N splitter 368 to a plurality of emitters 324 of the OPA 320. For lower bandwidth operations and a simpler layout, the pathlengths may be set to be approximately a multiple of 2 times an effective index of refraction times a wavelength, where the total path mismatch would be inversely proportional to the reduced bandwidth capability. In some instances, the physical distance between the tap coupler 314 and the one or more multiplexers 308 may be a length (on the order of 100 ums) such that fabrication tolerances and thermal gradient may not cause any relative phase errors between the propagating signals generated at the laser source 302 and the one or more control wavelengths generated at laser source 350. In this regard the dispersion between the signals and one or more control wavelengths may be small enough so that relative phase errors are relatively small or a small offset or other phase shifter control value (offset-locking) can be applied by one or more phase shifters of the PIC layer 300 to compensate for any differences.

The input PIC 214 may be configured in the same or similar manner as the PIC layer 300 of FIGS. 3A-3B. The input PIC 214 may include additional components that may support digitization of a test pattern and a test pattern input preparation. In this regard, when the PIC layer 300 is configured as an input PIC 214, the one or more processors 360 may be further configured to encode the test pattern or components thereof onto a signal (e.g., light) to be transmitted from OPA 320 (Tx signal). The signal may be propagated through, operated on, and transmitted by each layer of the ONN. The test pattern may be an image to be analyzed by the ONN, such as a test image. In such an instance where the test pattern is a test image, the one or more processors 360 may be configured to digitize the test pattern into, for example, matrix form. Alternatively, the test pattern may be received in digitized form, such as, for example, matrix form.

The encoded components of the test pattern may be different features thereof. In one example, different components may include different color spectra (e.g., red, green, blue for visible light). Encoding components of the test pattern may include encoding multiple wavelengths onto a signal. For example, a first encoded wavelength may include the red light component of the test pattern, a second encoded wavelength may include the green light component of the test pattern, and a third encoded wavelength may include the blue light component of the test pattern. The components of the test pattern may be encoded onto an optical signal generated at the laser source 302 via the plurality of phase shifters 304 and the plurality of amplitude modulators 306, processed using the one or more control wavelengths of the OC subsystem 340 and transmitted from the OPA 320 as discussed above with respect to FIGS. 3A-3B.

In some instances, a single component (e.g., single color spectra component, object, characteristic, etc.) may be encoded onto a signal. The input PIC 214 may be configured to transmit the signal including the test pattern via the OPA 320. In addition to processing colors of light simultaneously, in general the ONN can concurrently process multiple forms of signals that could be decomposed into a separable basis set; for example, frequency based signals may include audio, electronic, radio frequency, x-ray, magnetic resonance, etc.

The one or more convolution PIC layers 218 may be configured in the same or similar manner as the PIC layer 300 of FIGS. 3A-3B. The one or more convolution PIC layers 218 may include additional components that may support signal processing and/or signal filtering (e.g., matrix multiplication of the test pattern and a target pattern mask). In this regard, when the PIC layer 300 is configured as one or more convolution PIC layers 218, OPA 320 may be configured to receive signals including the one or more components of the test pattern from the input PIC 214. The one or more processors 360 may be configured to apply a target pattern as a filter or mask to signals including the test pattern from the input PIC 214. The one or more target patterns may include example images to be compared to or correlated to the test pattern. In some instances, the one or more target patterns may be in the Fourier Transform (FT) domain. In some instances, the one or more target patterns may include training data.

The filtering or mask application may be achieved via one or more convolution operations. For example, if the target pattern includes an image of the letter A, the test pattern signal may be filtered using the target pattern such that only instances or peaks of the test pattern corresponding to the letter A may remain. In other words, instances of overlap between an expression of the target pattern and the test pattern may survive the filtering. The one or more processors, may be further configured to transmit the filtered signal including the test pattern by driving the one or more phase shifters.

In some instances, the one or more convolution PIC layers 218 may be a plurality of convolution PIC layers. Each of the plurality of convolution PIC layers may be configured to filter or apply a component of the target pattern to a corresponding component of the test pattern. Like the components of the test pattern, in one example, the different components of the target pattern may include different color spectra (e.g., red, green, blue for visible light). In this regard, each convolution PIC layer may be configured to apply a filter corresponding to a component of the target pattern to the signal including the test pattern. Additionally or alternatively, the target pattern may be a plurality of target patterns which may each be applied to the test pattern or components thereof in a differing layer of the plurality of convolution PIC layers.

In such instances, the filtered signal from the one or more convolution PIC layers 218 may include multiple wavelengths each corresponding to the filtering performed in each convolution PIC layer. In some instances, each convolution PIC layer may apply its respective filter in parallel.

In some instances, the filter or mask of the one or more convolution PIC layers may be dynamically changed through use of the plurality of phase shifters 304 and plurality of amplitude modulators 306. Such dynamic change enables high speed comparison of the test pattern against the target pattern.

Following the filtering of the signal including the test pattern, the one or more convolution layers 218 may be configured to transmit the filtered signal via OPA 320 to the analyzer PIC 222. In some instances, the one or more convolution PIC layers 218 may include separate transmit and receive OPAs instead of a bidirectional OPA, such as OPA 320. In this regard, the one or more convolution PIC layers 218 may be configured to receive signals from the input PIC 214 at a receive OPA and transmit filtered signals using a transmit OPA to the analyzer PIC 222.

In some instances, the one or more convolution PIC layers 218 may be configured encode components of the target pattern on a signal in in the same manner as discussed above with respect to the encoding of the test pattern in the input PIC 214 Alternatively, in some instances, the target pattern may be received as a signal from a target PIC 224. The target PIC 224 may be configured in the same or similar manner as the PIC layer 300 of FIGS. 3A-3B. The target PIC 224 may include additional components that may support digitization of a target pattern for preparation as a mask in the one or more convolution PIC layers 218. When the PIC layer 300 is configured as a target PIC 224, the one or more processors 360 may be further configured to encode the target pattern or components thereof pattern onto a signal to be transmitted from OPA 320. In an instance where the target pattern is a target image, the one or more processors 360 may be configured to digitize the target pattern into, for example, matrix form. Alternatively, the target pattern may be received in a digitized form, such as, for example, received in matrix form. The components of the target pattern may be encoded onto an optical signal generated at the laser source 302 via the plurality of phase shifters 304 and the plurality of amplitude modulators 306, processed using the one or more control wavelengths of the OC subsystem 340 and transmitted from the OPA 320 as discussed above with respect to FIGS. 3A-3B. The transmitted signal may then be received by the one or more convolution PIC layers 218.

In some instances, a single component (e.g., single color spectra component, object, characteristic, etc.) may be encoded onto a signal. The target PIC 224 may be configured to transmit the signal including the test pattern via the OPA 320. In addition to processing colors of light simultaneously, in general the ONN can concurrently process multiple forms of signals that could be decomposed into a separable basis set; for example, frequency based signals may include audio, electronic, radio frequency, x-ray, magnetic resonance, etc.

In some instances, the target PIC 224 may not include OPA 320. In this regard, the target PIC 224 may be connected to the one or more convolution PIC layers 218 via a plurality of waveguides, plurality of optical fibers, etc. In some instances, the target PIC 224 may include a lens or other components that may transform the encoded signal into the Fourier domain for filtering. The lens may be configured in the same manner as the first lens 216 and second lens 220, discussed in further detail below.

The analyzer PIC 222 may be configured in the same or similar manner as the PIC layer 300 of FIGS. 3A-3B. The analyzer PIC 222 may include additional components that may support direct or coherent detection of filtered signals from the one or more convolution PIC layers 218. The one or more processors 360 may be configured to compare a filtered signal received from the one or more convolution PIC layers 218 to a threshold. The threshold may be a confidence level threshold. In some instances, the threshold may be a plurality of thresholds, where each threshold corresponds to a different component of the test pattern. In this regard, the filtered signal being equal to or above the threshold may be indicative of the target pattern, or components thereof, being present in the test pattern. Additionally, the filtered signal being below the threshold may be indicative of the target pattern, or components thereof, not being present in the test pattern. The results of the comparison may be in the form of a correlation matrix or include components of a correlation matrix.

In some instances, the one or more processors 360 may be further configured to output the results of the comparison of the filtered beam to the threshold. The output results may be saved in the memory 106 of the ONN 102 and/or in an external device. In one instance, the results of the comparison may include if the test pattern contains one or more components or parameters of the target pattern (e.g., a determination of a class of the test pattern). In another instance, the results of the comparison may include if the target pattern is contained in the test pattern (e.g., recognition of an image in the test pattern).

Additionally, the one or more processors 360 may be further configured to induce the ONN 102 to repeat the filtering process until the threshold is met and/or until each component of the test pattern is filtered by a target pattern. In some instances, the one or more processors 360 may be the same as the one or more processors 104 of the ONN 102 and may include a central processing unit.

The first lens 216 and second lens 220 may be configured to perform a FT and inverse Fourier Transform (IFT), respectively, on signals passing therethrough. In this regard, the filtering conducted in the one or more convolution PIC layers 218 may be conducted in the FT domain. In some instances, the first lens 216 and second lens 220 may be configured to perform a Fast Fourier Transform (FFT) and inverse Fast Fourier Transform (IFFT), respectively, on optical beams passing therethrough.

In some instances, the first lens 216 and second lens 220 may be meta-lenses. In one example, the first and second lenses may each be formed as an OPA with bidirectional or both transmit and receive capabilities and may include a silicon meta-lens. Such an OPA may include the same or similar components as discussed above with respect to FIGS. 3A-B. In such an example, the OPA may be integrated on a PIC silicon wafer carrier.

In another example, the first lens 216 and second lens 220 may be formed as stacked interlayered multiple planar diffractive cell layers. In a further example, the first and second lenses may each be formed as a glass surface with a semiconductor layer thereon. The semiconductor layer may be formed in a manner that allows for the FFT and IFFT respectively to be performed. In a further example, the first and second lenses may be included in a micro lens array. In this regard, the lenses of the micro lens array of the input PIC 214, the one or more convolution PIC layers 218, the analyzer PIC 222, or any combination thereof may be configured to perform FT, IFT, etc. on signals. The first lens 216 and second lens 220 can be a bulk optic, micro-lens array, diffractive optic, micro-printed lens array or meta-lens or any combination thereof.

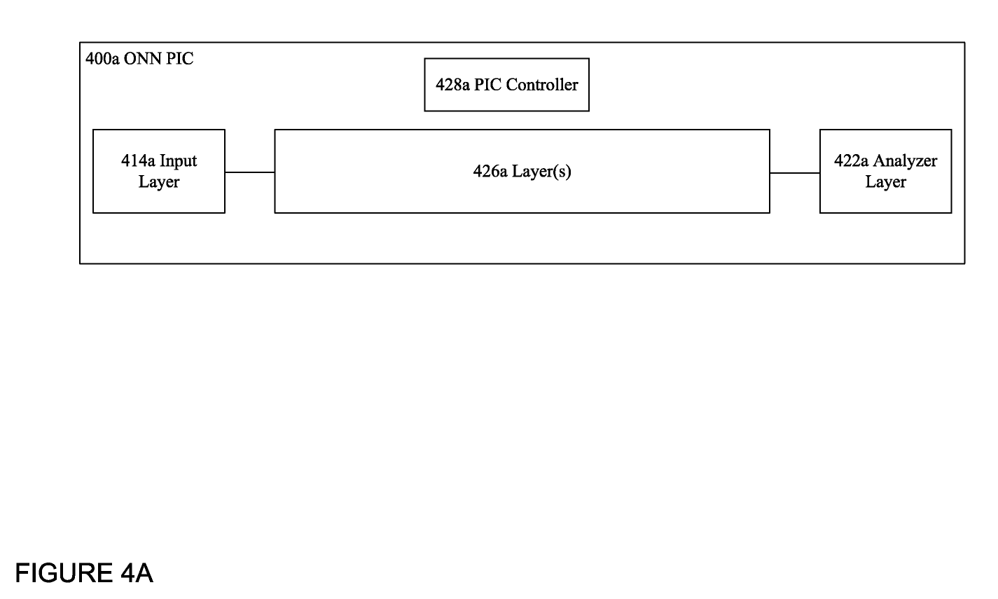

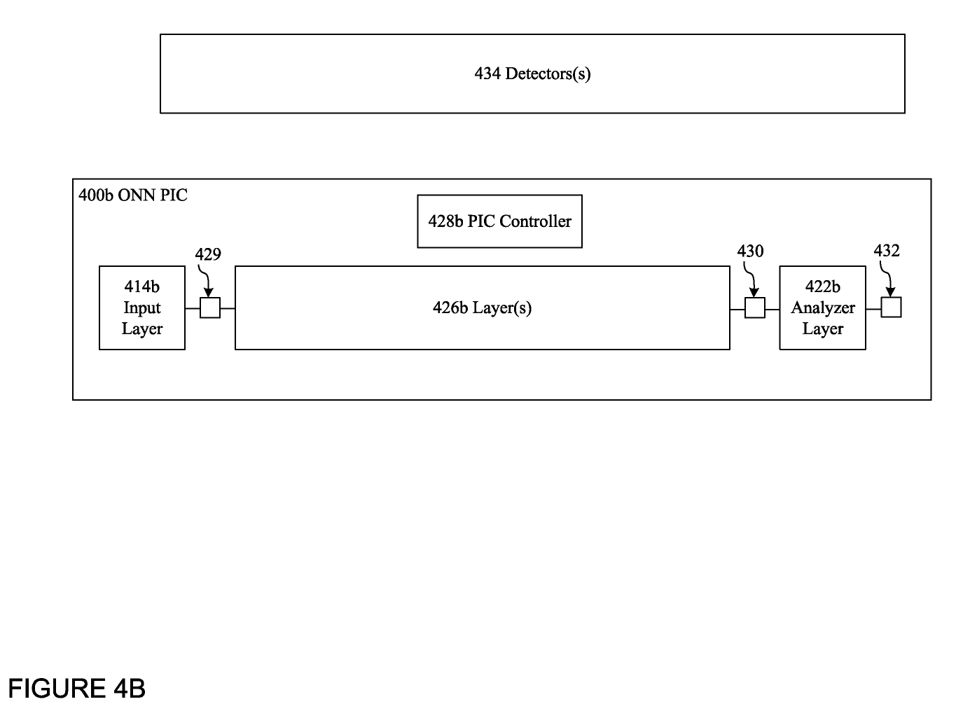

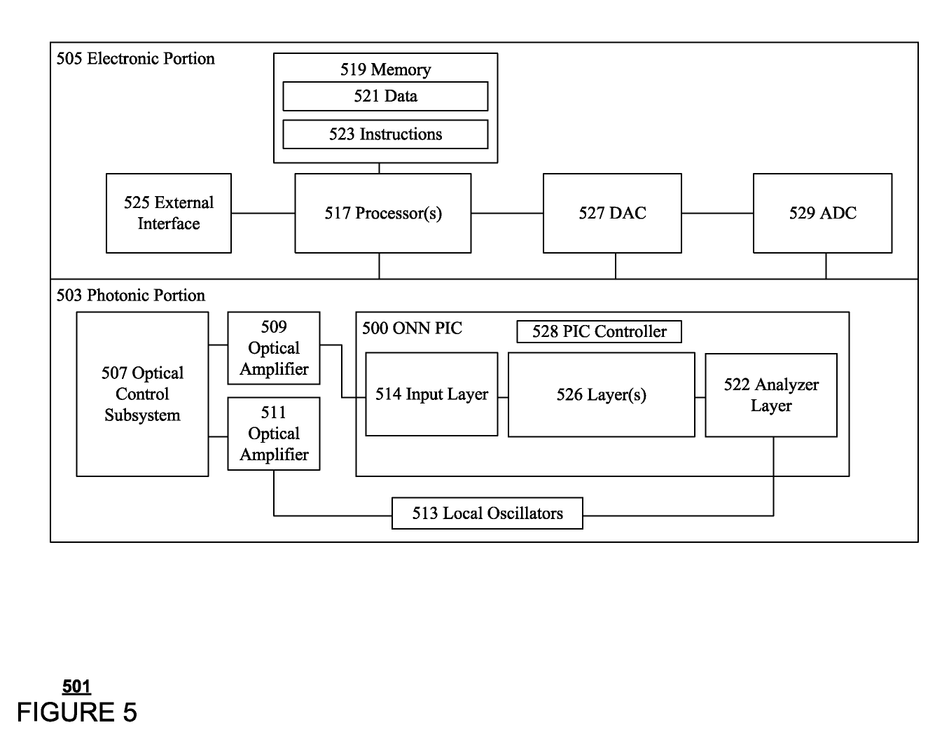

In some instances, the ONN may be implemented on a single PIC. In this regard, each layer of a plurality of layers of the ONN may be constructed on a single PIC chip as opposed to discrete PICs for each layer. FIGS. 4A-B illustrates an example ONN PICs 400a-b including an input layer 414a-b, an analyzer layer 424a-b, one or more layers 426a-b, and PIC controller 248a-b. The input layer 414a may function in the same or similar manner to input PIC 214a. In this regard, input layer 414a may be configured in the same or similar manner as the PIC layer 300 of FIGS. 3A-3B. The input layer 414a may include additional components that may support digitization of a test pattern and a test pattern input preparation. In this regard, when the PIC layer 300 is configured as an input layer 414a, the one or more processors 360 may be further configured to encode the test pattern or components thereof onto a Tx signal to be transmitted via OPA 320. The test pattern may be an image to be analyzed by the ONN PIC 400a, such as a test image. In such an instance where the test pattern is a test image, the one or more processors 360 may be configured to digitize the test pattern into, for example, matrix form. Alternatively, the test pattern may be received in digitized form, such as, for example, matrix form. The one or more processors 360 may be formed as part of PIC controller 428a. In this regard, each layer (e.g., input layer 414a, analyzer layer 422a, one or more layers 426a) may not include a dedicated processor and instead may be controlled by one or more processors of controller 428a.

The encoded components of the test pattern may be different features thereof. In one example, different components may include different color spectra (e.g., red, green, blue for visible light). Encoding components of the test pattern may include encoding multiple wavelengths onto a signal. For example, a first encoded wavelength may include the red light component of the test pattern, a second encoded wavelength may include the green light component of the test pattern, and a third encoded wavelength may include the blue light component of the test pattern. The components of the test pattern may be encoded onto an optical signal generated at the laser source 302 via the plurality of phase shifters 304 and the plurality of amplitude modulators 306, processed using the one or more control wavelengths of the OC subsystem 340 and transmitted from the OPA 320 as discussed above with respect to FIGS. 3A-3B.

In some instances, a single component (e.g., single color spectra component, object, characteristic, etc.) may be encoded onto a signal. The input layer 414 may be configured to transmit the signal including the test pattern via the OPA 320. In addition to processing colors of light simultaneously, in general the ONN PIC 400a can concurrently process multiple forms of signals that could be decomposed into a separable basis set; for example, frequency based signals may include audio, electronic, radio frequency, x-ray, magnetic resonance, etc.

In some instances, the input layer 414a may not include OPA 320. In this regard, the input layer 414a may be connected to the one or more layers 426a via a plurality of waveguides, plurality of optical fibers, etc.

The input layer 414b may be configured in a similar manner as input layer 414a. However, input layer 414b may not include the OC subsystem 340 disposed therein. In one example, the OC subsystem 340 may be included in a separate portion of the ONN PIC 400b. In another example, the OC subsystem 340 may be separate from the ONN PIC 400b. Such an example may include the configuration of OC subsystem 507 and OC subsystem 607 discussed below with reference to FIGS. 5-7.

Additionally, an OPA, configured in a similar manner as OPA 320, of input layer 414b may not include a plurality of reflectors, such as the plurality of reflectors 328. Instead, the ONN PIC 400b may include one or more reflectors 429 disposed between input layer 414b and one or more layers 426b. The one or more reflectors 429 may be configured to reflect one or more control wavelengths, like the one or more control wavelengths discussed above, from the external OC subsystem to one or more detectors 434. The one or more detectors 434 (e.g., camera, photodetectors, etc.) may be in a separate plane from the ONN PIC 400b. The one or more detectors 434 may be configured to measure one or more values such intensity, power, and/or relative phase of the one or more control wavelengths. The measured values may be used in control and/or analysis of the one or more control wavelengths (e.g., as feedback) by one or more processors operatively connected with the ONN PIC 400b. In this regard, the one or more processors may use the measured values in control and/or the analysis of components of the ONN PIC, the OC subsystem, or some combination thereof.

The analyzer layer 422a may function in the same or similar manner to analyzer PIC 222. In this regard, the analyzer layer 422a may be configured in the same or similar manner as the PIC layer 300 of FIGS. 3A-3B. The analyzer layer 422a may include additional components that may support direct or coherent detection of filtered signals from the one or more layers 426a. The one or more processors 360 may be configured to compare a filtered signal received from the one or more layers 426a to a threshold. The threshold may be a confidence level threshold. In some instances, the threshold may be a plurality of thresholds, where each threshold corresponds to a different component of the test pattern. In this regard, the filtered signal being equal to or above the threshold may be indicative of the target pattern, or components thereof, being present in the test pattern. Additionally, the filtered signal being below the threshold may be indicative of the target pattern, or components thereof, not being present in the test pattern. The results of the comparison may be in the form of a correlation matrix or include components of a correlation matrix.

In some instances, the one or more processors 360 may be further configured to output the results of the comparison of the filtered beam to the threshold. The output results may be saved in a memory (not shown) operatively connected of the ONN PIC 400a. The memory may be external to the ONN PIC 400a. In one instance, the results of the comparison may include if the test pattern contains one or more components or parameters of the target pattern (e.g., a determination of a class of the test pattern). In another instance, the results of the comparison may identify whether or not the target pattern is contained in the test pattern (e.g., recognition of an image in the test pattern) or a likelihood of the target pattern is contained in the test pattern.

Additionally, the one or more processors 360 may be further configured to induce the ONN PIC 400a to repeat the filtering process until the threshold is met and/or until each component of the test pattern is filtered by a target pattern. The one or more processors 360 may be formed as part of controller 428a. In this regard, each layer (e.g., input layer 414a, analyzer layer 422a, one or more layers 426a) may not include a dedicated processor and instead may be controlled by one or more processors of controller 428a.

In some instances, the analyzer layer 422a may not include OPA 320. In this regard, the analyzer layer 422a may be connected to the one or more layers 426a via a plurality of waveguides, plurality of optical fibers, etc.

The analyzer layer 422b may be configured in a similar manner as analyzer layer 422a. However, analyzer layer 422b may not include the OC subsystem 340 disposed therein. In one example, the OC subsystem 340 may be included in a separate portion of the ONN PIC 400b. In another example, the OC subsystem 340 may be separate from the ONN PIC 400b. Such an example may include the configuration of OC subsystem 507 and OC subsystem 607 discussed below with reference to FIGS. 5-7.

Additionally, an OPA, configured in a similar manner as OPA 320, of analyzer layer 422b may not include a plurality of reflectors, such as the plurality of reflectors 328. Instead, the ONN PIC 400b may include one or more reflectors 432 disposed at an output of the analyzer layer 422b. The one or more reflectors 432 may be configured to reflect one or more control wavelengths, like the one or more control wavelengths discussed above, from the external OC subsystem to the one or more detectors 434. The one or more detectors 434 (e.g., camera, photodetectors, etc.) may be in a separate plane from the ONN PIC 400b. The one or more detectors 434 may be configured to measure one or more values such intensity, power, and/or relative phase of the one or more control wavelengths. The measured values may be used in control and/or analysis of the one or more control wavelengths (e.g., as feedback) by one or more processors operatively connected with the ONN PIC 400b. In this regard, the one or more processors may use the measured values in control and/or the analysis of components of the ONN PIC, the OC subsystem, or some combination thereof.

The one or more layers 426a may include the same or similar layers as the ONN of FIG. 2 as discussed above. In this regard, the one or more layers 426a of the ONN PIC 400a may include one or more convolutions layers. The one or more convolution layers of the one or more layers 426a may be configured in the same or similar manner as the one or more convolution PIC layers 218. In this regard, the one or more convolution layers may be configured in the same or similar manner as the PIC layer 300 of FIGS. 3A-3B. The one or more convolution layers may include additional components that may support signal processing and/or signal filtering (e.g., matrix multiplication of the test pattern and a target pattern mask). In this regard, when the PIC layer 300 is configured as one or more convolution layers, OPA 320 may be configured to receive signals including the one or more components of the test pattern from the input layer 414a. The one or more processors 360 may be configured to apply a target pattern as a filter or mask to signals including the test pattern from the input layer 414a. The one or more target patterns may include example images to be compared to or correlated to the test pattern. In some instances, the one or more target patterns may be in the Fourier Transform (FT) domain. In some instances, the one or more target patterns may include training data.

The filtering or mask application may be achieved via one or more convolution operations. For example, if the target pattern includes an image of the letter A, the test pattern signal may be filtered using the target pattern such that only instances or peaks of the test pattern corresponding to the letter A may remain. In other words, instances of overlap between an expression of the target pattern and the test pattern may survive the filtering. The one or more processors, may be further configured to transmit the filtered signal including the test pattern by driving the one or more phase shifters. The one or more processors 360 may be formed as part of controller 428a. In this regard, each layer (e.g., input layer 414a, analyzer layer 422a, one or more layers 426a) may not include a dedicated processor and instead may be controlled by one or more processors of controller 428a.

In some instances, the one or more convolution layers may be a plurality of convolution PIC layers. Each of the plurality of convolution PIC layers may be configured to filter or apply a component of the target pattern to a corresponding component of the test pattern. Like the components of the test pattern, in one example, the different components of the target pattern may include different color spectra (e.g., red, green, blue for visible light). In this regard, each convolution layer may be configured to apply a filter corresponding to a component of the target pattern to the signal including the test pattern. Additionally or alternatively, the target pattern may be a plurality of target patterns which may each be applied to the test pattern or components thereof in a differing layer of the plurality of convolution layers.

In such instances, the filtered signal from the one or more convolution layers may include multiple wavelengths each corresponding to the filtering performed in each convolution layer. In some instances, each layer may apply its respective filter in parallel.

In some instances, the filter or mask applied via one or more convolution layers may be dynamically changed through use of the plurality of phase shifters 304 and plurality of amplitude modulators 306. Such dynamic change enables high speed comparison of the test pattern against the target pattern.

Following the filtering of the filtered signal including the test pattern, the one or more convolution layers may be configured to transmit the filtered signal via OPA 320 to the analyzer layer 422a. In some instances, the one or more convolution layers may include separate transmit and receive OPAs instead of a bidirectional OPA, such as OPA 320. In this regard, the one or more convolution layers may be configured to receive signals from the input layer 414a at a receive OPA and transmit filtered signals using a transmit OPA to the analyzer layer 422a. In some instances, the one or more convolution layers may not include OPA 320. In this regard, the one or more convolution layers may be connected to the input layer 414a and the analyzer layer 422a via a plurality of waveguides, plurality of optical fibers, etc.

In some instances, the one or more convolution layers may be configured encode components of the target pattern on a signal in in the same manner as discussed above with respect to the encoding of the test pattern in the input layer 414a Alternatively, in some instances, the one or more layers 426a may additionally include a target layer. The target layer of the one or more layers 426a may be configured in the same or similar manner to target PIC 224a. In this regard, the target layer of the one or more layers 426a may be configured in the same or similar manner as the PIC layer 300 of FIGS. 3A-3B. The target layer may include additional components that may support digitization of a target pattern for preparation as a mask in the one or more convolution layers. When the PIC layer 300 is configured as a target layer 224, the one or more processors 360 may be further configured to encode the target pattern or components thereof pattern onto a signal to be transmitted from via OPA 320. The one or more processors 360 may be formed as part of controller 428a. In this regard, each layer (e.g., input layer 414a, analyzer layer 422a, one or more layers 426a) may not include a dedicated processor and instead may be controlled by one or more processors of controller 428a.

In an instance where the target pattern is a target image, the one or more processors 360 may be configured to digitize the target pattern into, for example, matrix form. Alternatively, the target pattern may be received in digitized form, such as, for example, matrix. The components of the target pattern may be encoded onto an optical signal generated at the laser source 302 via the plurality of phase shifters 304 and the plurality of amplitude modulators 306, processed using the one or more control wavelengths of the OC subsystem 340 and transmitted from the OPA 320 as discussed above with respect to FIGS. 3A-3B. The transmitted signal may then be received by the one or more convolution layers.

In some instances, a single component (e.g., single color spectra component, object, characteristic, etc.) may be encoded onto a signal. The target layer may be configured to transmit the signal including the test pattern via the OPA 320. In addition to processing colors of light simultaneously, in general the ONN can concurrently process multiple forms of signals that could be decomposed into a separable basis set; for example, frequency based signals may include audio, electronic, radio frequency, x-ray, magnetic resonance, etc.

In some instances, the target layer may not include OPA 320. In this regard, the target layer may be connected to the one or more convolution layers via a plurality of waveguides, plurality of optical fibers, etc. In some instances, the target layer may include a lens or other components that may transform the encoded signal into the Fourier domain for filtering. The lens may be configured in the same manner as a first lens and second lens of the one or more layers 426a, discussed in further detail below.

The one or more convolutions layers and/or the target layer of one or more layers 426b may be configured in a similar manner as the one or more convolutions layers and/or the target layer of one or more layers 426a. However, one or more convolutions layers and/or the target layer of one or more layers 426b may each not include the OC subsystem 340 disposed therein. In one example, the OC subsystem 340 may be included in a separate portion of the ONN PIC 400b. In another example, the OC subsystem 340 may be separate from the ONN PIC 400b. Such an example may include the configuration of OC subsystem 507 and OC subsystem 607 discussed below with reference to FIGS. 5-7.

Additionally, OPAs, configured in a similar manner as OPA 320, of the one or more convolutions layers and/or the target layer of one or more layers 426b may not include a plurality of reflectors, such as the plurality of reflectors 328. Instead, the ONN PIC 400b may include one or more reflectors 430 disposed at an output of one or more layers 426b. The one or more reflectors 430 may be configured to reflect one or more control wavelengths, like the one or more control wavelengths discussed above, from the external OC subsystem to the one or more detectors 434. The one or more detectors 434 (e.g., camera, photodetectors, etc.) may be in a separate plane from the ONN PIC 400b. The one or more detectors 434 may be configured to measure one or more values such intensity, power, and/or relative phase of the one or more control wavelengths. The measured values may be used in control and/or analysis of the one or more control wavelengths (e.g., as feedback) by one or more processors operatively connected with the ONN PIC 400b. In this regard, the one or more processors may use the measured values in control and/or the analysis of components of the ONN PIC, the OC subsystem, or some combination thereof.

In some instances, the one or more layers 426a of the ONN PIC 400a may include a first lens and a second lens. The first lens and the second lens of the one or more layers 426a may be configured in the same or similar manner as the first lens 216 and the second lens 220. In this regard the first lens and second lens may be configured to perform a FT and an IFT, respectively, on signals passing therethrough. In this regard, the filtering conducted in the one or more convolution layers of the one or more layers 426a may be conducted in the FT domain. In some instances, the first lens and second lens may be configured to perform an FFT and an IFFT, respectively, on optical beams passing therethrough.

In some instances, the first lens and second lens may be meta-lenses. In one example, the first and second lenses may each be formed as an OPA with Tx and Rx capabilities and may include a silicon meta-lens. Such an OPA may include the same or similar components as discussed above with respect to FIGS. 3A-B.

In another example, the first lens and second lens may be formed as stacked interlayered multiple planar diffractive cell layers. In a further example, the first and second lenses may each be formed as a glass surface with a semiconductor layer thereon. The semiconductor layer may be formed in a manner that allows for the FFT and IFFT respectively to be performed. In a further example, the first and second lenses may be included in a micro lens array. In this regard, the lenses of the micro lens array of the input layer 414a, the one or more convolution layers of the one or more layers 426a, the analyzer layer 422a, or any combination thereof may be configured to perform FT, IFT, etc. on signals. The first lens and second lens can be a bulk optic, micro-lens array, diffractive optic, micro-printed lens array or meta-lens or any combination thereof.

In some instances, an ONN, such as ONN PIC 400a-b, may be included on a board. The board may include both an electronic portion with one or more electronic components and a photonics portion including one or more photonic components. The board may be operatively connected to one or more external components that support image processing. FIG. 5 illustrates an example board 501. The board 501 includes a photonic portion 503 and an electronic portion 505. The photonic portion 503 includes an OC subsystem 507, an optical amplifier 509, an optical amplifier 511, one or more local oscillators (LO) 513, and an ONN PIC 500. The electronic portion includes one or more processors 517, an external interface 525, a digital to analog converter (DAC) 527, and an analog to digital converter (ADC) 529. The

The OC subsystem 507 may be configured in the same or similar manner as the OC subsystem 340. In this regard, the components of the OC subsystem 507 may be used for phase and wavefront control. The OC subsystem 507 may be configured to correct static and dynamic relative or absolute phase errors throughout ONN PIC 500, the ONN PIC 500 being configured in the same or similar manner as the ONN PIC 400b, via the generation of one or more control wavelengths. The one or more control wavelengths may be used as a reference to correct static and dynamic phase errors throughout the ONN PIC 500 to control the relative or absolute phase of individual emitter pathways, and may allow for slightly different functionality across one or more of the layers thereof.

In some instances, the OC subsystem 507 may be configured to inject frequency tones into the generated one or more control wavelengths. The frequency tones may assist in temporal and spatial determinations of where phase errors occur within the ONN PIC 500. The frequency tones may be injected by a plurality of OC phase and amplitude modulators of the OC subsystem 507, configured in the same or similar manner as the plurality of OC phase and amplitude modulators 352. In one example, the frequency tone may be injected via dithering. The dithering may be time-division dithering, frequency division dithering, or some combination thereof. Dithers may be applied to differing subsets of the plurality of OC phase and amplitude modulators. Each subset may correspond to a function of the orthonormal set of functions. A phase and/or amplitude error associated with each dither may be determined by measuring power, amplitude, intensity, etc. resulting from each dither. A correction (e.g., compensation for the error) may be determined for each dither based on the determined phase and/ or amplitude error. In some instances, the power, amplitude, intensity, etc. may be measured by a plurality of OC PDs, configured in the same or similar manner as the plurality of OC PDs 356. Alternatively, in some instances, the power, amplitude, intensity, etc. may be measured by one or more detectors, configured in the same or similar manner as the one or more detectors 434.

The OC subsystem 507 is connected to the optical amplifier 509. The optical amplifier 509 may be configured to amplify one or more control wavelengths from the OC subsystem for propagation through the ONN PIC 500. In this regard, the optical amplifier 509 is connected to the input layer 514 on the ONN PIC 500. The OC subsystem 507 is additionally connected to the optical amplifier 511. The optical amplifier 511 may be configured to amplify one or more control wavelengths from the OC subsystem for propagation through the ONN PIC 500. In this regard, the optical amplifier 511 is connected to the analyzer layer 522 of the ONN PIC 500. As shown in FIG. 5, the one or more LOs 513 are disposed in a path between the optical amplifier 511 and the analyzer layer 522 of the ONN PIC 500. In some instances, the LOs 513 may be configured to inject one or more frequency tones on signals passing therethrough via dithering. The frequency tones may assist in temporal and spatial determinations of where phase errors occur within the ONN PIC 500.

The one or more processors 517 may be configured in the same or similar manner as the one or more processors 104. In this regard, the one or more processors 517 may be any conventional processors, such as commercially available CPUs. For example, one or more processors 517 may be one or more complementary metal-oxide semiconductor (CMOS) processors. Alternatively, the one or more processors 517 may be a dedicated device such as an application specific integrated circuit (ASIC) or another hardware-based processor, such as a field programmable gate array (FPGA).

Memory 519, operationally connected to one or more processors 517, may store information accessible by the one or more processors 517, including data 521, and instructions 523, that may be executed by the one or more processors 517. The memory 519 may be of any type capable of storing information accessible by the processor, including a computer-readable medium such as a hard-drive, memory card, ROM, RAM, DVD or other optical disks, as well as other write-capable and read-only memories. The system and method may include different combinations of the foregoing, whereby different portions of the data 521 and instructions 523 are stored on different types of media.

Data 521 may be retrieved, stored or modified by one or more processors 517 in accordance with the instructions 523. For instance, although the system and method are not limited by any particular data structure, the data 521 may be stored in computer registers, in a relational database as a table having a plurality of different fields and records, XML documents or flat files. The data 521 may also be formatted in any computer-readable format such as, but not limited to, binary values or Unicode. By further way of example only, image data may be stored as bitmaps including grids of pixels that are stored in accordance with formats that are compressed or uncompressed, lossless (e.g., BMP) or lossy (e.g., JPEG), and bitmap or vector- based (e.g., SVG), as well as computer instructions for drawing graphics. The data 521 may comprise any information sufficient to identify the relevant information, such as numbers, descriptive text, proprietary codes, references to data stored in other areas of the same memory or different memories (including other network locations) or information that is used by a function to calculate the relevant data.

The instructions 523 may be any set of instructions to be executed directly (such as machine code) or indirectly (such as scripts) by the one or more processors 517. For example, the instructions 523 may be stored as computer code on the computer-readable medium. In that regard, the terms "instructions" and "programs" may be used interchangeably herein. The instructions 523 may be stored in object code format for direct processing by the one or more processors 517, or in any other computer language including scripts or collections of independent source code modules that are interpreted on demand or compiled in advance. Functions, methods and routines of the instructions 523 are explained in more detail below.

The one or more processors 517 may be configured to prepare target patterns and test patterns for injection into the ONN PIC 500 via the digital to analog converter (DAC) 527. Similarly, the one or more processors 517 may be configured to receive outputs from the analyzer layer 522, the outputs resulting from image analysis via the analog to digital converter (ADC) 529.

The external interface 525 may be configured to connect one or more components of the board 501 with external components (e.g., client devices, external memory, etc.). The external components may include one or more components of other boards, such as one or more photonic components. The other boards may be within the same storage element of a data center (e.g., enclosure or rack). Additionally or alternatively the other boards may be in a different storage element within the same data center or different data center.

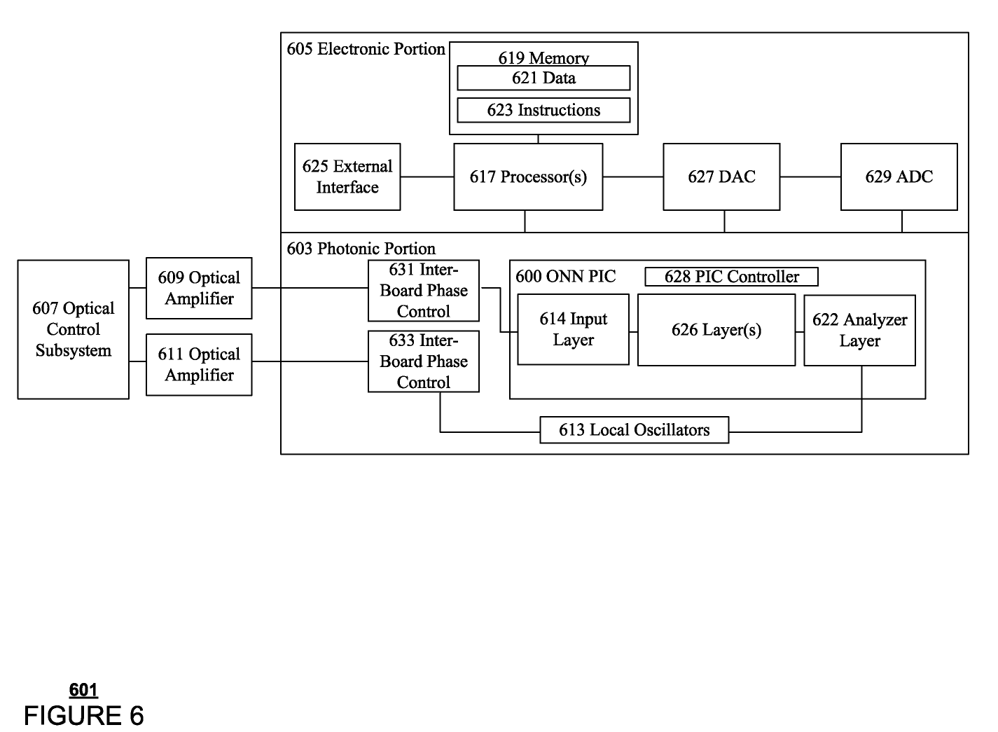

In some instances, a board may be configured to analyze images in tandem with a plurality of other boards. In this regard, the plurality of boards may simultaneously analyze different components of an image (e.g., red light component, green light component, blue light component, different characteristics of the image, etc.). FIG. 6 illustrates an example board 601 configured to analyze images in tandem with a plurality of other boards. The board 601 includes a photonic portion 603 and an electronic portion 605. The photonic portion 603 includes inter-board phase control unit 631, inter-board phase control unit 633, one or more LOs 613, and an ONN PIC 600. The photonics portion 603 of the board 601 is connected to an external OC subsystem 607, external optical amplifier 609, and external optical amplifier 611. The electronic portion includes one or more processors 617, an external interface 625, a DAC 627, and an ADC 629.

The OC subsystem 607 may be configured in the same or similar manner as the OC subsystem 640 and OC subsystem 507. In this regard, the components of the OC subsystem 607 may be used for phase and wavefront control. The OC subsystem 607 may be configured to correct static and dynamic relative or absolute phase errors throughout ONN PIC 600, the ONN PIC 600 being configured in the same or similar manner as the ONN PIC 400b and ONN PIC 500, via the generation of one or more control wavelengths. The one or more control wavelengths may be used as a reference to correct static and dynamic phase errors throughout the ONN PIC 600 to control the relative or absolute phase of individual emitter pathways, and may allow for slightly different functionality across one or more of the layers thereof.

In some instances, the OC subsystem 607 may be configured to inject frequency tones into the generated one or more control wavelengths. The frequency tones may assist in temporal and spatial determinations of where phase errors occur within the ONN PIC 600. The frequency tones may be injected by a plurality of OC phase and amplitude modulators of the OC subsystem 607, configured in the same or similar manner as the plurality of OC phase and amplitude modulators 352. In one example, the frequency tone may be injected via dithering. The dithering may be time-division dithering, frequency division dithering, or some combination thereof. Dithers may be applied to differing subsets of the plurality of OC phase and amplitude modulators. Each subset may correspond to a function of the orthonormal set of functions. A phase and/or amplitude error associated with each dither may be determined by measuring power, amplitude, intensity, etc. resulting from each dither. A correction (e.g., compensation for the error) may be determined for each dither based on the determined phase and/ or amplitude error. In some instances, the power, amplitude, intensity, etc. may be measured by a plurality of OC PDs, configured in the same or similar manner as the plurality of OC PDs 356. Alternatively, in some instances, the power, amplitude, intensity, etc. may be measured by one or more detectors, configured in the same or similar manner as the one or more detectors 434.

The OC subsystem 607 is connected to the optical amplifier 609. The optical amplifier 609 may be configured to amplify one or more control wavelengths from the OC subsystem for propagation through the ONN PIC 600. In this regard, the optical amplifier 609 is connected to the input layer 614 on the ONN PIC 560. The OC subsystem 607 is additionally connected to the optical amplifier 611. The optical amplifier 611 may be configured to amplify one or more control wavelengths from the OC subsystem for propagation through the ONN PIC 600. In this regard, the optical amplifier 611 is connected to the analyzer layer 622 of the ONN PIC 600.

As shown in FIG. 6, the inter-board phase control unit 631 is disposed in a path between optical amplifier 609 and input layer 614. The inter-board phase control unit 631 may prevent wavelengths and/or phases outside of a particular range from passing therethrough. The particular range may be received from the one or more processors 517 to allow for a specific component or components of an image to be analyzed. In some instances, the wavelength and/or phase can be locked to a specific wavelength and/or phase for coherent homodyne receiver applications or can be slightly offset for coherent heterodyne receiver applications.

Similarly, the inter-board phase control unit 633 is disposed in a path between optical amplifier 609 and analyzer layer 622. The inter-board phase control unit 633 may prevent wavelengths and/or phases outside of a particular range from passing therethrough. The particular range may be received from the one or more processors 517 to allow for a specific component or components of an image to be analyzed. In some instances, the wavelength and/or phase can be locked to a specific wavelength and/or phase for coherent homodyne receiver applications or can be slightly offset for coherent heterodyne receiver applications.

In addition, the one or more LOs 613 are disposed in a path between the optical amplifier 611 and the analyzer layer 622 of the ONN PIC 600. In some instances, the LOs 613 may be configured to inject one or more frequency tones on signals passing therethrough via dithering. The frequency tones may assist in temporal and spatial determinations of where phase errors occur within the ONN PIC 600.

The one or more processors 617 may be configured in the same or similar manner as the one or more processors 104 and the one or more processors 517. In this regard, the one or more processors 617 may be any conventional processors, such as commercially available CPUs. For example, one or more processors 617 may be one or more complementary metal-oxide semiconductor (CMOS) processors. Alternatively, the one or more processors 617 may be a dedicated device such as an application specific integrated circuit (ASIC) or another hardware-based processor, such as a field programmable gate array (FPGA).

Memory 619, operationally connected to one or more processors 617, may store information accessible by the one or more processors 617, including data 621, and instructions 623, that may be executed by the one or more processors 617. The memory 619 may be of any type capable of storing information accessible by the processor, including a computer-readable medium such as a hard-drive, memory card, ROM, RAM, DVD or other optical disks, as well as other write-capable and read-only memories. The system and method may include different combinations of the foregoing, whereby different portions of the data 621 and instructions 623 are stored on different types of media.

Data 621 may be retrieved, stored or modified by one or more processors 617 in accordance with the instructions 623. For instance, although the system and method are not limited by any particular data structure, the data 621 may be stored in computer registers, in a relational database as a table having a plurality of different fields and records, XML documents or flat files. The data 621 may also be formatted in any computer-readable format such as, but not limited to, binary values or Unicode. By further way of example only, image data may be stored as bitmaps including grids of pixels that are stored in accordance with formats that are compressed or uncompressed, lossless (e.g., BMP) or lossy (e.g., JPEG), and bitmap or vector- based (e.g., SVG), as well as computer instructions for drawing graphics. The data 621 may comprise any information sufficient to identify the relevant information, such as numbers, descriptive text, proprietary codes, references to data stored in other areas of the same memory or different memories (including other network locations) or information that is used by a function to calculate the relevant data.

The instructions 623 may be any set of instructions to be executed directly (such as machine code) or indirectly (such as scripts) by the one or more processors 617. For example, the instructions 623 may be stored as computer code on the computer-readable medium. In that regard, the terms "instructions" and "programs" may be used interchangeably herein. The instructions 623 may be stored in object code format for direct processing by the one or more processors 617, or in any other computer language including scripts or collections of independent source code modules that are interpreted on demand or compiled in advance. Functions, methods and routines of the instructions 623 are explained in more detail below.

The one or more processors 617 may be configured to prepare target patterns and test patterns for injection into the ONN PIC 600 via the digital to analog converter (DAC) 627. Similarly, the one or more processors 617 may be configured to receive outputs from the analyzer layer 622, the outputs resulting from image analysis via the analog to digital converter (ADC) 629.

The external interface 625 may be configured to connect one or more components of the board 601 with external components (e.g., OC subsystem 607, client devices, external memory, etc.). The external components may include one or more components of other boards, such as one or more photonic components. The other boards may be within the same storage element of a data center (e.g., enclosure or rack). Additionally or alternatively the other boards may be in a different storage element within the same data center or different data center.

Additionally, the one or more processors 617 of the board 601 may be configured to communicate with one or more other boards, configured in the same or similar manner, also connected to the OC subsystem 607. In this regard, the communication may allow for synchronization of image analysis in time. Additionally, the communication may allow for each board to analyze a different portion of images. In this regard, the communication may allow one or more processors, such as one or more processors 617, of each board to drive the inter-board phase control units such as, inter-board phase control units 631, 633 to allow a different wavelengths and/or phases associated with an image to be analyzed at each board.

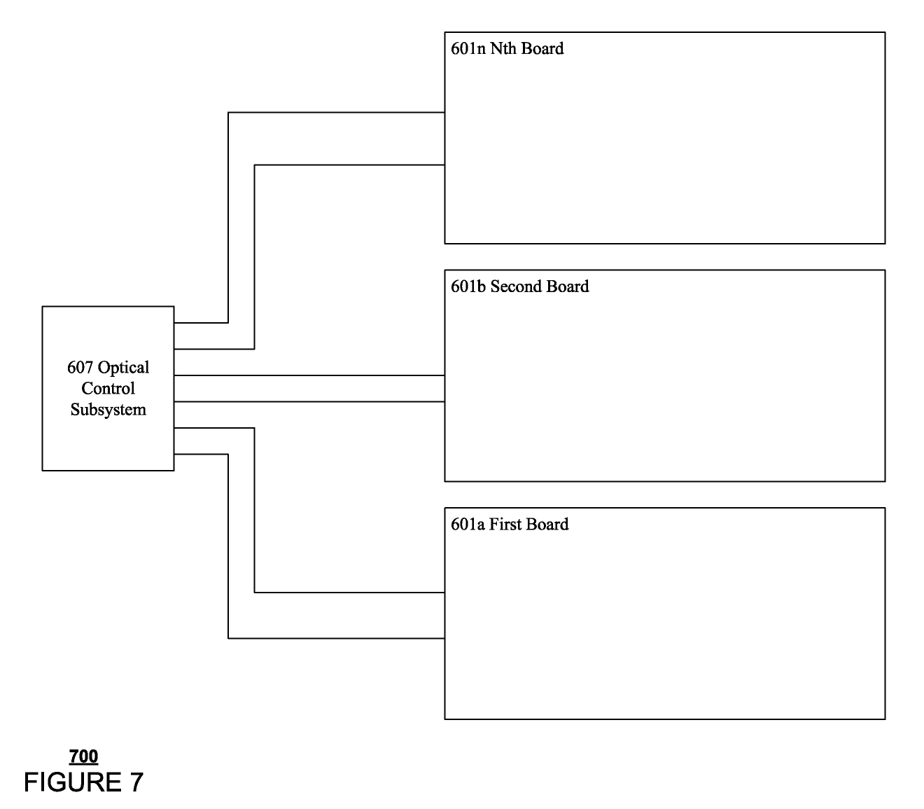

FIG. 7 illustrates an example system 700 including a plurality of boards 601a-n configured to analyze images in tandem. The plurality of boards 601a-n may include N boards (e.g., a first board 601a, a second board 601b..., and an Nth board 601n). The number of boards of the plurality of boards 601a-n may correspond to a number of components of an image to be analyzed.

### EXAMPLE METHODS

As discussed above, the ONN implemented using PICs, may be used in a method of analyzing an image. The analysis of images may be directed towards different ends. In one instance, the ONN may classify images (e.g. perform image classification tasks). In such an instance, a test pattern may be analyzed to determine the class of images to which it belongs. In such an instance, the results of the analysis may identify whether the test pattern contains one or more components or parameters of the target pattern. For example, for a test image including a flower, the ONN may be configured to determine the type of flower (e.g., iris) in an image. In some examples, the ONN may be further configured to determine a sub-class or species of flow (e.g., iris setosa, iris versicolor, or iris virginica).

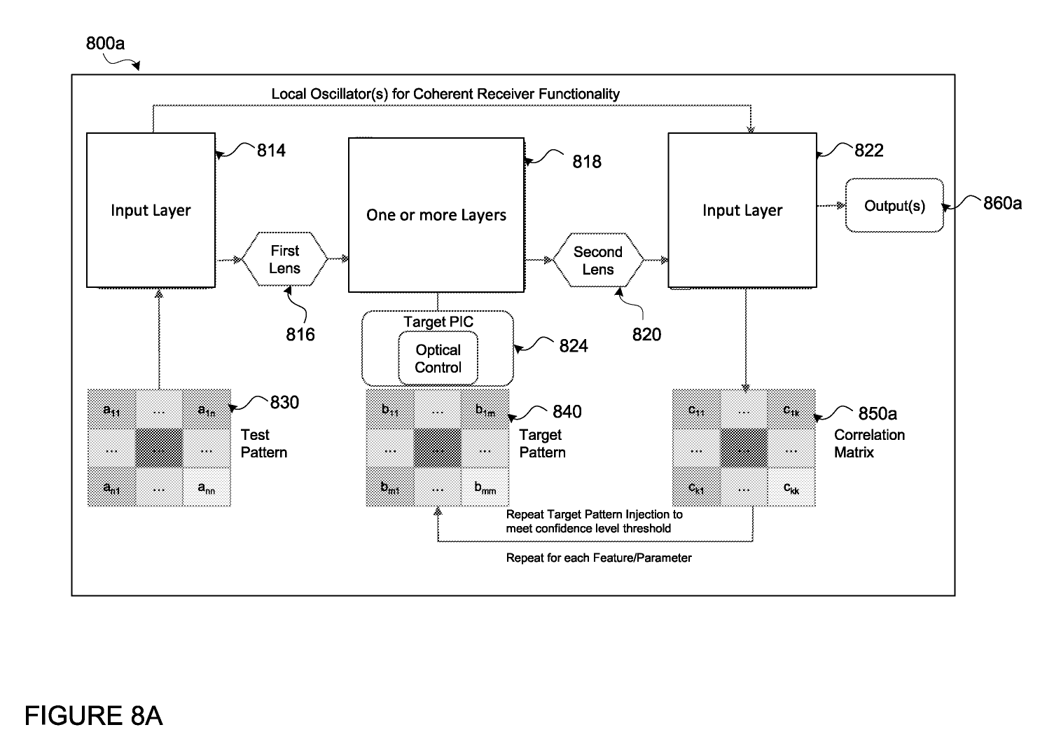

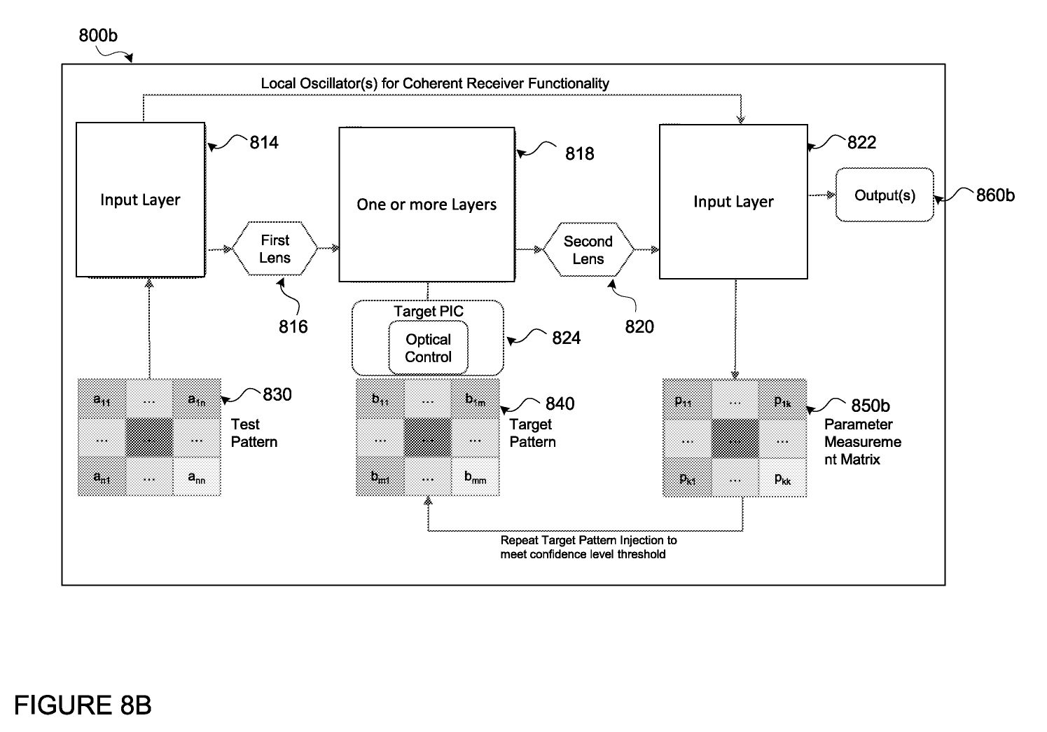

FIG. 8A illustrates an example pictorial method flow of an ONN 800a configured to classify images. ONN 800a may be configured in the same or similar manner as ONN 102 or ONN PIC 400a-b, 500, 600, 600a-n. In this regard, the input layer 814 may be configured to receive a test pattern 830. The input layer 814 may encode the test pattern on a signal and transmit the signal as discussed above. The signal may be transformed into the FT domain via first lens 816 and received by the one or more convolution layers 818. As discussed above, the one or more convolution layers 818 may apply a filter or mask based on one or more target patterns 840 encoded on a signal by and received from target layer 824. A filtered signal may be transmitted by the one or more convolution layers 818 through the second lens 820. The filtered signal may be transformed out of the FT domain and be received by analyzer layer 822. The analyzer layer 822 may be configured to compare the filtered signal to one or more thresholds as discussed above. The results of the comparison may be a correlation matrix 850a. The filtering by the one or more convolution layers 818 may be repeated until the threshold is met. Additionally, the filtering may be repeated for each parameter pertaining to a class of images. Then, analyzer layer 822 may output the results of the comparison as outputs 860a. The results of the comparison may be in the form of a correlation matrix or include components of correlation matrix 850a.

In other instances, the ONN may recognize certain patterns or other information in images and/or the image itself (e.g., perform image recognition tasks). In such an instance, the results of the analysis may include if the target pattern is contained in the test pattern. By way of example, the ONN may recognize text. In such an example, the ONN may determine if a specific number, letter, or other character is present in a test pattern.

In some instances, as discussed above, the ONN may be included in a board configured to analyze images in tandem with a plurality of other boards. In this regard, the plurality of boards may simultaneously analyze different components of an image (e.g., red light component, green light component, blue light component, different characteristics of the image, etc.). In such an instance, a plurality of boards (e.g., boards 601a-n) may be configured to communicate with one or more other boards, configured in the same or similar manner. In this regard, the communication may allow for synchronization of image analysis in time. Additionally, the communication may allow for each board to analyze a different portion of images. In this regard, the communication may allow one or more processors, such as one or more processors 617, of each board to drive the inter-board phase control units such as, inter-board phase control units 631, 633 to allow a different wavelengths and/or phases associated with an image to be analyzed at each board.

FIG. 8B illustrates an example pictorial method flow of an ONN 800b configured to perform image recognition. ONN 800b may be configured in the same or similar manner as ONN 102 or ONN PIC 400a-b, 500, 600, 600a-n. In this regard, the input layer 814 may be configured to receive a test pattern 830. The input layer 814 may encode the test pattern on a signal and transmit the signal as discussed above. The signal may be transformed into the FT domain via first lens 816 and received by the one or more convolution layers 818. As discussed above, the one or more convolution layers 818 may apply a filter or mask based on one or more target patterns 840 encoded on a signal by and received from target layer 824. A filtered signal may be transmitted by the one or more convolution layers 818 through the second lens 820. The filtered signal may be transformed out of the FT domain and be received by analyzer layer 822. The analyzer layer 822 may be configured to compare the filtered signal to one or more thresholds as discussed above. The results of the comparison may be a correlation matrix 850b. The filtering by the one or more convolution layers 818 may be repeated until the threshold is met for the image to be recognized. Then, analyzer layer 822 may output the results of the comparison as outputs 860b. The results of the comparison may be in the form of a correlation matrix or include components of correlation matrix 850b.

In some instances, as discussed above, the ONN may be included in a board configured to analyze images in tandem with a plurality of other boards. In this regard, the plurality of boards may simultaneously analyze different components of an image (e.g., red light component, green light component, blue light component, different characteristics of the image, etc.). In such an instance, a plurality of boards (e.g., boards 601a-n) may be configured to communicate with one or more other boards, configured in the same or similar manner. In this regard, the communication may allow for synchronization of image analysis in time. Additionally, the communication may allow for each board to analyze a different portion of images. In this regard, the communication may allow one or more processors, such as one or more processors 617, of each board to drive the inter-board phase control units such as, inter-board phase control units 631, 633 to allow a different wavelengths and/or phases associated with an image to be analyzed at each board.

The features and methodology described herein may provide a scalable ONN capable of processing large amounts of data and perform complex operations without the hindrances of electronic counterparts. In this regard, the ONN may utilize the scalability of the OPA to compute complex matrix-vector multiplication, have the advantages of ultra-high bandwidth, high calculation speed, high parallelism over electronic counterparts, and ultralow power consumption. Moreover, the PIC approach configured with OPAs leverages advances in complementary metal oxide semiconductor (CMOS) fabrication technologies to replace bulk centimeter sized ONN components with integrated micron level semiconductor photonics constructs. These CMOS compatible photonics can be directly integrated with CMOS electronics to provide complete ONN chips akin to electronic central processing unit (CPU) and graphics processing unit (GPU). This also allows ONN chip manufacture at the volume and cost scale required for next generation wide-spread speech recognition, image classification, computer vision and natural language processing applications. Additionally, extra dimensions enable system improvements such as wavelength division and spatial mode multiplexing that provides multi-thread processing with almost no extra computing overhead, leading to ultralow energy consumption that can drive system key performance metrics.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as "such as," "including" and the like, should not be interpreted as limiting the subject matter of the claims to the specific examples; rather, the examples are intended to illustrate only one of many possible embodiments. Further, the same reference numbers in different drawings can identify the same or similar elements.

1. A system comprising:
an optical neural network (ONN) photonic integrated circuit (PIC) formed as a plurality of layers, the ONN PIC comprising:
an input layer, the input layer configured to transmit signals including one or more test patterns, wherein each test pattern represents an image to be analyzed,
one or more convolution layers, the one or more convolution layers configured to filter received signals including one or more test patterns based on one or more target patterns, and
an analyzer layer, the analyzer layer configured to compare filtered signals from the one or more convolution layers to one or more thresholds; and
an optical control subsystem operatively connected to the ONN PIC, the optical control subsystem configured to generate one or more control wavelengths including one or more frequency tones, wherein the one or more control wavelengths are configured to assist with determinations of where phase errors occur within the ONN PIC.

2. The system of claim 1, wherein the ONN PIC is included on a photonic portion of a board, the board comprising the photonic portion and an electronic portion including one or more electronic components.

3. The system of claim 2, wherein the optical control subsystem is included on the photonic portion of the board.

4. The system of claim 2, wherein the optical control subsystem is external to the board.

5. The system of claim 1, wherein the input layer, the one or more convolution layers, and the analyzer layer are connected via one or more waveguides.

6. The system of claim 1, wherein the ONN PIC is a plurality of ONN PICS.

7. The system of claim 6, wherein the plurality of ONN PICS are each included on a photonic portion of a corresponding board of a plurality of boards, each corresponding board comprising a photonic portion and an electronic portion including one or more electronic components.

8. The system of claim 7, wherein the optical control subsystem is external to the plurality of boards.

9. The system of claim 6, wherein:
each target pattern of the one or more target patterns includes a plurality of components; and
each ONN PIC of the plurality of ONN PICs receives a different component of the plurality of components for each target pattern.

10. The system of claim 9, wherein each ONN PIC of the plurality of ONN PICs receives the different component of the plurality of components for each target pattern simultaneously.

11. The system of claim 1, further comprising a first lens disposed in a path between the input layer and the one or more convolution layers, the first lens configured to perform a Fourier Transform (FT) on signals passing therethrough.

12. The system of claim 11, further comprising a second lens disposed in a path between the one or more convolution layers and an analyzer layer, the second lens configured to perform inverse Fourier Transform (IFT) on signals passing therethrough.

13. The system of claim 12, wherein the FT is Fast Fourier Transform (FFT) and the IFT is an inverse Fast Fourier Transform (IFFT).

14. The system of claim 11, wherein the first lens is a meta-lens.

15. The system of claim 11, wherein the first lens is a stacked interlayered multiple planar diffractive cell layer.

16. The system of claim 1, wherein the comparison results in a determination of a class of a test pattern or recognition of an image in the test pattern.

17. The system of claim 1, wherein the ONN PIC further comprises:
a first reflector disposed at an output of the input layer;
a second reflector disposed at an output of the one or more convolution layers; and
a third reflector disposed at an output of the analyzer layer,
wherein the first reflector, second reflector, and third reflector are configured to reflect the one or more control wavelengths to one or more detectors.

18. The system of claim 17, wherein the one or more detectors are in a separate plane from the ONN PIC.

19. The system of claim 1, wherein the one or more thresholds is a confidence level threshold.

20. The system of claim 1, wherein the one or more thresholds is a plurality of thresholds and each of the plurality of thresholds corresponds to a different component of a test pattern of the one or more test patterns.
